(19) United States
(12) Patent Application Publication
(10) Pub. No.: US 2004/0073453 A1
(43) Pub. Date: Apr. 15, 2004

(54) Method and system for dispensing communication devices to provide access to patient-related information

(76) Inventors: Valeriy I. Nenov, Los Angeles, CA (US); Neil A. Martin, Encino, CA (US); Farzad D. Buxey, Cantebury Drive, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/250,696

(22) PCT Filed: Jan. 10, 2002
(86) PCT No.: PCT/US02/00881

(51) Int. Cl. G06F 17/60; G06F 15/16

(52) U.S. Cl. 705/2; 709/203

(57) ABSTRACT

A method and system supply information concerning a patient. The method provides a display device that is a dedicated part of a system to a person. The display device is configured to display information concerning a patient, The system receives a first data set concerning the patient, transmits the first data set in digitized form to a server and stores the first data set as patient information. The system transmits at least a portion of the stored patient information from the server to the display device.

### BACKGROUND OF THE INVENTION

1. Field of the Invention

The present invention relates in general to the use of computing devices in a hospital environment, and relates in particular to renting computing devices to individuals for access to patient specific information.

2. Description of the Related Art

Family members of acutely hospitalized patients are usually very concerned about the health of their loved ones. Immediate family members and relatives for a hospitalized patient often gather for hours or days in hospital waiting rooms, lobbies, and cafeterias while awaiting information on the status of their hospitalized relative. They often take hotel rooms nearby for extended stays. Many times, relatives are viewed as a “necessary nuisance” by clinicians and caregivers because they want to know more and more information. Relatives will many times make many attempts in person and by phone to request more information while at the same time sometimes interfering with the jobs that clinicians and caregivers are attempting to complete.

In a hospital setting, relatives of critically ill hospitalized patients often receive information that is frequently insufficient, incomplete, and less than timely. Much of the time, relatives are away from the patient's bedside and do not have access to information they would like to have. The severity of the problem varies from hospital to hospital as well as from setting to setting within a given hospital. Much of the inconsistency results from availability, workload, qualification and personal interests of the critical care and administrative staff. A study of 24 ward doctors from 5 medical departments showed that from the average daily working time of 8.6 hours, including the time spent on communication with patients and their families, an average of 4 minutes was spent on communication with each patient and 1 minute with the patient's family. (Hauser, W., & Schwebius, P. (1999). [Four minutes for the patient and one minute for the families. Physician-patient-family communication in medical departments.] Psychother Psychosom Med Psychol, 49(5), 168-70).

The main reason for this lack of information is the current method of communication. Presently, some information communicated to relatives comes from person-to-person verbal communications which are usually untimely and sometimes difficult to comprehend in lay person's terms. Information is simply given in a disorganized manner as relatives have to wait to receive information verbally from nurses or attending physicians on a catch-as-catch-can basis. Other information communicated to relatives comes from information fliers, pamphlets, and brochures distributed to relatives that are often outdated. Relatives have to make a concerted effort to gather and interpret diverse types of information, which may or may not be entirely pertinent to the stay of the patient and which may not address the specific questions that the relatives may wish to have answered. Further, all of the present methods of communication force patients' relatives to consume information in a passive fashion. Relatives rarely play a significant role in providing information that will be helpful for treatment of the patient.

Based on the foregoing, a need exists for providing information to relatives and for relatives to provide information to medical personnel in a more efficient and effective manner. Relatives should have the ability to find out the current status of the hospitalized patient at any given time. There should also be access to the principal diagnoses and outcome prognosis in addition to disease-specific information. Relatives should also be promptly informed about critical new information about the patient's status. Post-discharge plans such as follow up care and explanations of physicians' plans for further treatment and tests should also be easily accessible. Many times, relatives would like to see the cost of treatment and the proportion which the insurance company is expected to cover.

To help put relatives at ease, relatives also need easy access to subjects that are difficult to discuss with medical personnel such as exploring different alternatives, such as second opinions or referrals. Finally, to help make relatives feel more at ease during their wait, general information such as travel information and local hotels and restaurants should be provided to relatives.

Physicians also have a need for more efficient and organized data. Physicians must perform different tasks such as clinical, case management, and administrative functions. Physicians are in need of a portable one stop location to perform all of these functions at one time.

### SUMMARY OF THE INVENTION

One aspect of the present invention is a method of supplying information concerning a patient. In accordance with this aspect, the method comprises providing a display device that is a dedicated part of a system to a person. The display device is configured to display information concerning a patient. The system receives a first data set concerning the patient, transmits the first data set in digitized form to a server, and stores the first data set as patient information. The system also transmits at least a portion of the stored patient information from the server to the display device. Preferably, the method processes the first data set before the portion of the data set is transmitted from the server to the display device. In particular embodiments, the information transmitted to the display device includes at least a portion of data from the first data set. For example, the data set concerning the patient includes one or more of vital sign data, historical data concerning the patient, physical examination data, lab result data, and imaging results data. Advantageously, the person to whom the display device is provided is a relative of the patient, a friend of the patient, a physician, a nurse, or another member of the medical personnel of a hospital or other care facility. Advantageously, the display device is integrated with a computing device to allow display of the information. For example, the computing device can be a Personal Digital Assistant (PDA), a two-way pager with Personal Digital Assistant functionality, a Wireless Application Protocol (WAP) phone. Preferably, the computing device is a microprocessor-based computer. The connections to the computing device are preferably wireless connections, and the information is transmitted from an RF transmitter to an RF receiver. The transmitted information advantageously includes case management information, such as, for example, administrative data, clinical data. The display device may be provided to the person by renting, selling or lending.

Another aspect of the present invention is a method of supplying information concerning a patient. In accordance with this aspect, the method comprises providing a display device to a person, the display device configured to display information concerning a patient; receiving a first data set concerning the patient; transmitting the first data set in digitized form to a server; storing the first data set as patient information; and transmitting at least a portion of the stored patient information from the server to the display device.

Another aspect of the present invention is a method of providing information concerning a patient. In accordance with this aspect, the method comprises dispensing a display device that is a dedicated part of a system to a person. The display device is configured to display information concerning a patient. The system receives a first data set concerning the patient; transmits the first data set in digitized form over a network to a server that stores the first data set as patient information; transmits at least a portion of the patient information from the server to a display device over the network; and receives additional patient information over the network from a person to enhance delivery of health care to the patient.

Another aspect of the present invention is a system of providing information concerning a patient. In accordance with this aspect, the system comprises a hospital information service, which manages patient related information. A first server receives data from the hospital information service. The first server stores data in a first database. The system includes patient monitors which receive a data set concerning a patient, and includes a monitor acquisition module which receives data from the patient monitors. The monitor acquisition module stores the data from the patient monitors in a second database. A second server accesses the second database and transmits data over a network to a display device that is dispensed to a person. In particular embodiments, the first database and the second database are combined in a single database. In certain embodiments, the display device is advantageously integrated with a computing device to allow display of the information.

Another aspect of the present invention is a method of renting a device to a person affiliated with a patient situated in a hospital. In accordance with this aspect, the method comprises contacting the person to make the person an offer to rent the device, and entering into a contract with the person regarding usage and rental conditions. The method creates a customized account for the person, and then provides communication capability between the hospital and the person wherein the person can request and receive patient related information via the device, and wherein the hospital can communicate with the patient when needed. The customized account preferably includes a level of access, an enabled service, or a charge level. The patient related information advantageously includes at least one of patient specific information, hospital specific information, or disease specific information. Preferably, the hospital can page the person via the device.

Another aspect of the present invention is a method of providing a communication service between a hospital and a person affiliated with a patient. In accordance with this aspect, the method comprises contacting the person to make the relative an offer to buy the communication service; entering into a contract with the person regarding usage and purchase conditions; loading a software module on to the PDA of the person; activating the software module for the duration of the contract; and providing communication capability between the hospital and the person, wherein the person can request and receive patient-related information.

Another aspect of the present invention is a method of providing a display device to medical personnel to communicate with a hospital regarding patient-related information. In accordance with this aspect, the method comprises dispensing a display device to a medical person; enabling the medical person to log on to a server via the display device; providing to the medical person a list of patients via the display device; transmitting to the medical person relevant patient specific data in response to a selection made by the medical person from the list of patients; receiving case management information entered by the medical person via the display device after reviewing the patient specific data and examining the patient, and providing the physician with transmission capabilities through the display device for the data in the session. For example, the medical person may be a doctor, a nurse, or other staff member. The case management information advantageously includes clinical data, and may also advantageously include administrative data.

Another aspect of the present invention is method of providing information concerning a patient. In accordance with this aspect, the method comprises dispensing a software module configured to be integrated with a display device that is a dedicated part of a system to a person. The display device is configured to display information concerning a patient. The system receives a first data set concerning the patient; transmits the first data set in digitized form over a network to a server for storage therein as patient information; and transmits at least a portion of the patient information from the server to a display device over the network.

### BRIEF DESCRIPTION OF THE DRAWINGS

The embodiments of the present invention are described in more detail below in connection with the accompanying drawings in which:

FIG. 1 illustrates a schematic illustration of a system for dispensing display devices to provide information to people regarding patients in a hospital;

FIG. 2 illustrates one embodiment of a system to gather patient data and transmit it to the display device in FIG. 1;

FIG. 3 shows a software configuration developed to enable a person affiliated with the patient to obtain the patient related information;

FIG. 4 shows a network diagram of the hospital-wide hardware and network infrastructure for the software shown in FIG. 3;

FIG. 5 is a schematic view of the support system used to maintain the software and hardware configurations shown in FIGS. 3 and 4;

FIG. 6 shows one embodiment of a method for providing information a display device in the possession of the person affiliated with the patient;

FIG. 7 shows one embodiment of a method for dispensing device to medical personnel to communicate with a hospital regarding patient related information;

FIG. 8 shows one embodiment of a method for dispensing a PDA to a person affiliated with a patient (e.g., a relative or significant other); and

FIGS. 9A-9G are screen shots of the GUI seen by the person affiliated with the patient or the physician when using the display device 110.

### DETAILED DESCRIPTION OF THE PREFERRED EMBODIMENT

Embodiments of the present invention are described in detail below with reference to the figures, wherein like elements are referenced with like numerals throughout.

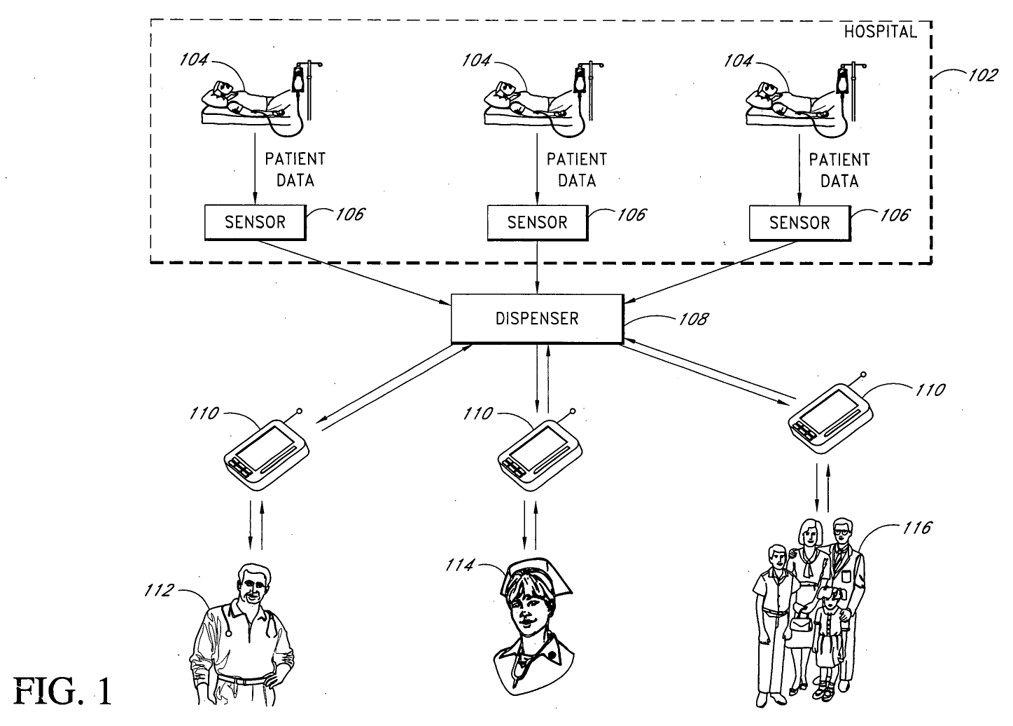

FIG. 1 illustrates a schematic illustration of a system for dispensing display devices to provide information to people regarding patients in a hospital 102. A dispenser 108 dispenses display devices 110 to a doctor 112, a nurse 114, a patient's relative 116, or any significant other or member of medical personnel that would be interested in acquiring information concerning a patient 104. The dispenser 108 receives information concerning the patient 104 from the sensor 106.

In one embodiment, the dispenser 108 is the hospital. Alternatively, the dispenser 108 is advantageously a third party vendor, such as, for example a medical supply service. The hospital can rent, sell, or lend a display device 110, such as a hand held device, to a person affiliated with the patient, such as, for example, relatives, significant others, or friends of patients in order to provide continuous patient specific information in a user friendly manner. Hand held devices include Personal Digital Assistants (PDAs) such as Palm Pilots, Pocket PCs, two-way pagers with PDA functionality (e.g., pagers made by Research In Motion (RIM) Limited), and Wireless Area Protocol (WAP) phones. In one embodiment, the hand held devices are wireless. The person affiliated with the patient can receive current information concerning the patient via the wireless handheld device whether the person is inside the hospital 102 or at a remote location.

According to another embodiment, the dispenser 108 sells, rents, or lends a software module to be configured with the person's own handheld device. The software module can be stored on a computer readable medium such as a disk or a data. storage card. Alternatively, the software module can be beamed using infrared technology or RF technology to an infrared port or to an RF port located on the handheld device. Medical personnel can load the software module on to the handheld device for the person. Alternatively, the dispenser 108 can provide self-serve machines that dispense the software modules. Payment methods such as credit cards and debit cards can be used in conjunction with dispensing the software modules. The dispenser 108 can program the software module to provide dedicated access to one particular patient upon request for a software module for that particular patient. The person affiliated with the patient can have a customized account with limited access rights to the system for the particular patient that the person is affiliated with. This embodiment is compliant with the Health Insurance Portability and Accountability Act (HIPAA) by maintaining the privacy and confidentiality of patient information. Generally, persons affiliated with one patient will not have access to patient information of another patient unless there is a separate affiliation. For instance, medical personnel would have access to multiple patients' profiles. Alternatively, the hospital 102 can provide the software module to the person who can then access multiple patients' data upon providing the necessary log in information.

In this configuration, the hand held device includes a 2-way interactive interface that allows the person to input patient related information in addition to receiving patient related information. The bi-directional flow of information enhances the delivery of health care because it allows people having a close relationship to the patient to provide information to medical personnel as the importance of certain information becomes necessary or more apparent. For instance, relatives of patients may remember some medical history after they leave the tense atmosphere of an Intensive Care Unit (ICU) and can then enter the data in a more relaxed setting. Accordingly, this embodiment allows people affiliated with the patient to advantageously take a more active role and thereby less stressful role in the patient's recovery.

In another embodiment, the hospital has an internet site which the person can access to retrieve patient related information. The person can use a microprocessor-based computer, such as, for example, a PC, to log on to the web site. If the person has a Personal Digital Assistant (PDA), the person can synchronize the data on the PC with a PDA. For example, the Palm Pilot produced by Palm Inc. offers a HotSync function which enables synchronization between a Palm Pilot and a PC. Alternatively, the person can log on to the web site through a PDA. In one embodiment, a software module can be downloaded using the HotSync function in order to use the handheld device for the transmission and receipt of patient related information.

In yet another embodiment, the hand held devices are distributed to medical personnel. As discussed above, medical personnel include a doctor 112, a nurse 114, or any other person working in the hospital to care for the patient. Medical personnel can access clinical data and lab data in addition to case management and administrative data in one portable location. A lengthy list of parameters or signals that can be accessed includes bio-potentials that provide information about the cerebral cortex, integrity of neural pathways, and muscle function or connectivity of a patient. In addition, the data includes vital signs such as, for example, heart rate, blood pressure, blood flow, and intracranial pressure. Finally, imaging modalities such as PET, MR, CT, and X-ray can be accessed through the handheld devices.

The data that can be accessed by either medical personnel or a person affiliated with the patient includes a variety of clinical, administrative, and historical data. The data that the person affiliated with the patient views is processed to provide the person with relevant data in an understandable fashion. Many people are not versed in medical terminology and clinical concepts. For example, detailed charts and graphs are advantageously summarized in layperson's terms. In one embodiment, a Natural Language Processing (NLP) system is used to interpret official clinical reports into a form more understandable by lay people. The NLP system can include computer based translation systems with or without the need for human assistance. The person can also access clinical events such as, for example, new reports, new test results, detected changes from normative values of the monitored parameters, and significant clinical observations made by the nurses. The person can also access a list of current medications, dosages, expected effects, observed effects and side effects of treatments.

In one embodiment, the dispenser 108 is a third party who dispenses the device to a person affiliated with the patient or medical personnel. The third party can sell, rent, or lend a handheld device to a person affiliated with a patient at a counter set up within the hospital, at a counter set up at a location outside of the hospital, or through a dispensing machine located inside or outside of the hospital 102. The third party coordinates with the hospital 102 to gain access to patient data and to perform subsequent processing of the data. Alternatively, the third party is responsible for only dispensing the devices, in which case, the hospital 102 provides the infrastructure to summarize and provide data to the devices.

In another embodiment, the dispenser 108 provides additional services that can be accessed through the display device 110. The person affiliated with the patient can access online reports on the patient status generated by the physicians. Further, the dispenser 108 automatically interprets the meaning of abnormal lab data and provides explanations of physician reports viewed by the person affiliated with the patient. If the person would like, the person can access the daily physicians' reports after patient rounds to be updated on the patient's progress. In addition, a person affiliated with the patient may take more comfort in knowing more information about the caregiver. Biographical information can be retrieved regarding the caregivers such as, for example, the physicians and nurses. The person can even access photographs of the caregivers to become more familiar with the roles of different people the person interacts with.

These additional services are helpful to the person affiliated with the patient because the additional services allow the person to monitor the treatment of the patient from a remote site. The person can access an online list of medications and dosages and a time line of their administration. Outbound and inbound paging is supported by the display device 110 to enable the medical personnel to contact the person in the case of an important event and to enable the person to page the medical personnel if the person notices some irregularity while viewing the data.

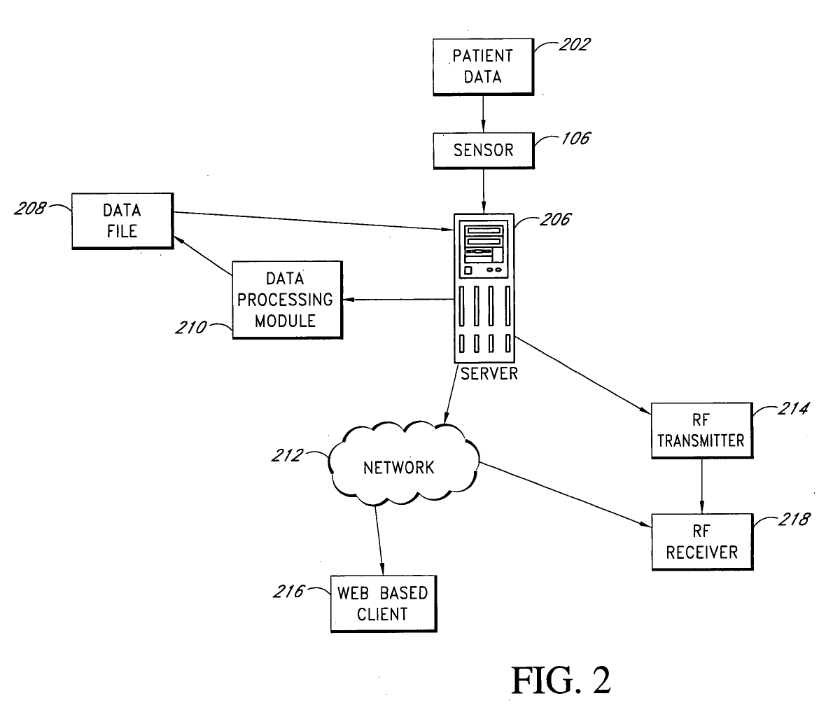

FIG. 2 illustrates one embodiment of a system to gather patient data and transmit it to the display device 110. The system includes at least one sensor 106 that receives patient data 202 and that transmits the patient data to a server 206 for eventual transmission to a web-based client 216 or to an RF Receiver 218.

The sensor 106 is preferably a patient monitor or a bedside device. For example, a patient monitor is advantageously a vital sign monitor (e.g., Hewlett Packard Viradia, Marquette Solar 8000) or a conventional EEG monitor (e.g., Niclolet Endeavor). Exemplary bedside devices include ventilators (e.g., Puritan Bennet 7200), infusion pumps (e.g., Baxter Flo-Gard), or the like. The sensor is operably connected to the patient to receive current patient data. The sensor converts the patient data to a digitized form and transmits the data to the server 206.

In one embodiment, the server 206 preferably processes the data before transmitting the data set it receives from the sensor 106. As discussed above with respect to FIG. 1, the average person affiliated with the patient wants an understandable summary of the patient data 202. Therefore, the server 206 transmits the patient data 202 to a data processing module 210. The data processing module 210 advantageously employs the NLP system discussed above with respect to FIG. 1 or any other data processing system that summarizes data for a layperson. After the patient data 202 is processed, the patient data 202 is stored as patient information in a data file 208. Upon a request for patient information or upon an automatic transmission such as an alert, the server can access the data file 208 to retrieve at least a portion of the data file for transmission. The server 206 may advantageously include voice recognition software and voice generation software so that the requests to and the information from the data processing module 210 may be provided verbally.

The alerts are calculated by a software module using automatic medical rules execution (AMREx). Clinical data such as labs or vitals can be used as inputs to clinical calculations, which are performed on-line in a quasi-real time fashion without the need of manual intervention by the caregiver. The calculations can yield diagnostic and/or prognostic statements like Fever, Hypertension, Metabolic Acidosis, etc. For instance, the Arterial Blood Gasses rule uses five vital signs to determine whether the patient has alkalosis or acidosis and whether the origin is metabolic or respiratory. When an abnormal lab or vital sign is recorded, the medical rule to which the parameters serve as inputs is automatically applied. Other data is also retrieved to refine the assessment of the abnormality. For instance, if Na+ is low, osmolality, urine output, and glucose levels are also checked and applied in the rules process. Further, the same software module or a different software module can perform automatic analysis of clinical events. Clinical events are significant changes of one or more measure parameters, i.e., when a parameter goes in or out of the normal range. For example, a clinical event would be a significant intracranial pressure (ICP) change such as more than 20 mm Hg for more than five minutes, an EEG seizure, or abnormal Burst-Suppression pattern. In response, at least a portion of the data file is transmitted to medical personnel with a suggested course of action.

The server 206 can then transmit at least a portion of the stored patient information to a network 212 or to a radio frequency (RF) transmitter 214 or to both. One skilled in the art will recognize that the network 212 can be the Internet, a local area network (LAN), a wireless network, a cable television (CATV) network, a satellite network, a Public Switched Telephone Network (PSTN), or any other communications network. As discussed above with respect to FIG. 1, the person affiliated with the patient can log on to the web site of the hospital 102 through the Internet via a web-based client 216. The web-based client 216 can be any microprocessor-based computer such as, for example, a PC. If the network 212 includes a wireless network, the server 206 can transmit to an RF receiver 218 through a wireless Internet Service Provider (ISP) or local area Wireless Ethernet (802.1b) network. The RF receiver 218 is preferably integrated with a PDA or other wireless handheld device that the person affiliated with the patient can use to access at least a portion of the stored patient information.

The RF transmitter 214 can also transmit at least a portion of the stored patient data to the RF receiver 218. This configuration is advantageous for a system based in the hospital 102 that includes the RF transmitter 214 for transmitting at least a portion of the stored patient information to handheld devices integrated with the RF receiver 218.

Alternatively, the server can transmit the patient data 202 that it receives from the sensor 106 in real time. This configuration is preferable for medical personnel because they usually like to see more detailed data than the person affiliated with the patient so that they can make their own summaries and conclusions.

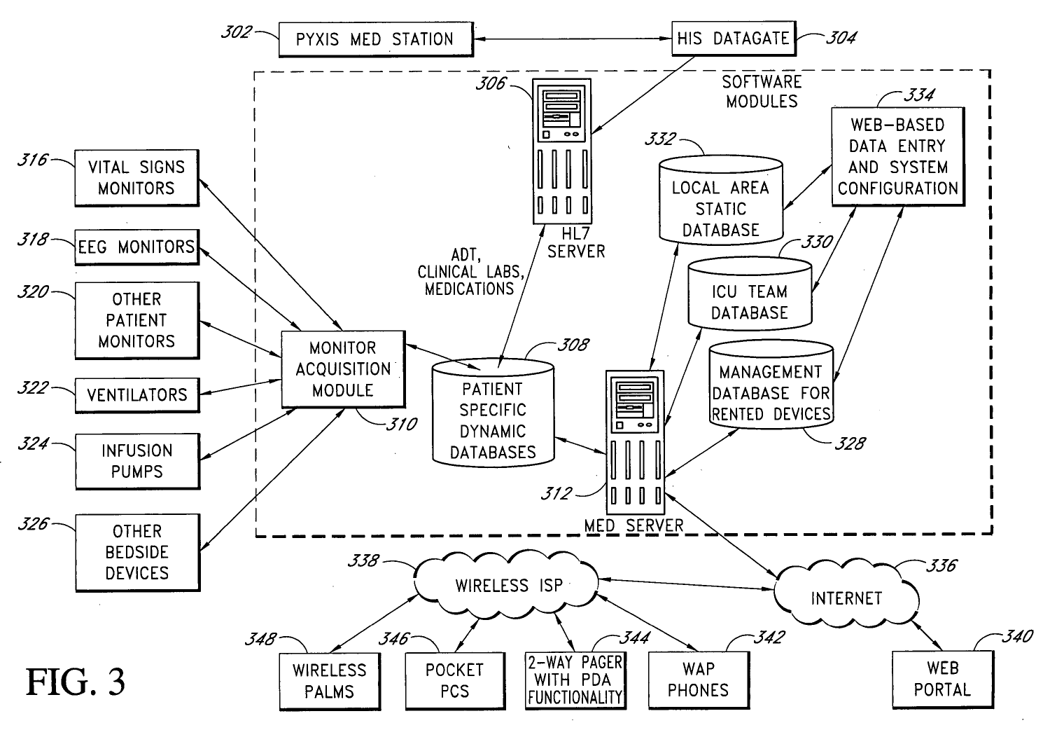

FIG. 3 shows a software configuration developed to enable a person affiliated with the patient to obtain the patient related information. In one embodiment, a client/server architecture is used to provide patient related information in a real time. The software component of the server resides preferably on a Windows NT/2000/XP server installed in the hospital 102. Other servers having other operating systems can also be used. The software component retrieves information and disseminates the information on demand to web-based clients or handheld devices. The software component abstracts and delivers only relevant information. In one embodiment, the software component includes a collection of software modules.

In one embodiment, the software component includes automated critical path (ACP) technology. A critical path is a plan for treatment of a patient, who has a particular diagnosis. The plan is followed as closely as possible by a team of caregivers, and the progress of the patient is monitored on a daily basis. If the progress is within well-known and expected boundaries, the critical path is continued as outlined and planned. If any parameters deviate significantly from the norm, an alternate and more individually tailored path is taken. If a critical path is followed as outlined, ordinarily it does not require much extra involvement on the part of the physician except for small tasks needed to be performed at various stages of the path. However, if a deviation from the critical plan is necessary, the physician needs to be notified and needs to get more involved in the treatment. As opposed to a paper-based recording system, the software component stores the steps of the critical path in a database. The software component includes a critical path manager, which is a rule-based system that is pre-coded to issue recommendations based upon the level of compliance with the treatments in accordance with the critical path. If there is a mismatch between the level of compliance and the predefined set of treatments, an alert is issued to a physician. The alert will notify the physician that a critical path step has not been executed or that there is a deviation in the patient's progress. Further, an online ordering system notifies the physician when an order does not fall within the critical path. This notification helps to avoid the ordering of non-essential tests, scans, procedures, etc., and contributes to cost effectiveness.

The software component of the client resides on the handheld devices. The software operates on the handheld devices in PUSH and PULL modes. The person uses PULL to retrieve data from the server such as specific patient related information. The person uses PUSH to provide the server with additional information. For instance, a family member may become aware of additional information historical information that may be of some use to physicians. The family member uses PUSH in order to send the information to the server. Different development kits (SDKs) are used to write software depending on the handheld device or PC used by the family member. In one embodiment, the Code Warrior for Palm OS R6 and Palm OS SDK 3.5 is used for wireless palms 348. The Blackberry handheld SDK 2.0 is used for the two-way pagers with PDA functionality 344. The UP SDK 4.0 is used for WAP phones 342. The software component of the client retrieves data through PULL mode and displays it to the end user via a graphical user interface (GUI) whose design is based on in-depth research of the perceived needs of the relatives. Preferably, the software component is user-friendly and consists of multiple interrelated display screens.

The software modules include a monitor acquisition module 310, an HL7 server 306, a MedServer 342, web-based data entry forms 334, client software, and databases for temporary storage. The software modules connect to monitors, internal information systems, and external networks to transmit and receive patient related data.

The monitor acquisition module 310 serves as an interface to the Intensive Care Unit (ICU) monitors and bedside devices. The ICU monitors include vital sign monitors 316, EEG monitors 318, and other patient monitors 320. The bedside devices include ventilators 322, infusion pumps 324, and other bedside devices 326. The monitor acquisition module 310 acquires the patient related data and stores the data in patient specific dynamic databases 308. The patient specific dynamic databases 308 stores patient specific data that changes on a daily basis. The stored patient specific data includes lab results, diagnoses and predicted outcomes, abstracted monitor data, abstracts from clinical reports, and, if needed, NLP processed data. The monitor acquisition module 310 is preferably built upon C/C++ technology.

The HL7 server 306 also stores data in the patient specific dynamic databases 308. The HL7 server is connected to a Hospital Information Service (HIS) datagate, which broadcasts hospital admission and discharge data (ADT), clinical labs, and medications to the HL7 server 306. The HIS datagate 340 is preferably connected to a Pyxis MedStation 302. The HL7 server 306 then stores the ADT, clinical labs, and medications in the patient specific dynamic databases 308. The information in the patient specific dynamic database 308 and the hospital information service may be advantageously combined in a single database.

The MedServer 342 is effectively a gateway between the databases and the software component of the client. The MedServer transmits data that is stored in the patient specific dynamic databases 308 to the Internet 336. The data can then be transmitted via active server pages (ASP) to a web portal 340 or to a wireless ISP 338. The wireless ISP 338 transmits the data to a variety of handheld devices such as, for example, wireless palms 348, pocket PCs 346, two-way pagers with PDA functionality 344, and WAP phones 342. The MedServer 342 also receives data through the Internet 336 from people affiliated with patients. The MedServer 342 then transmits the data to the patient specific dynamic databases 308 which can be accessed by the HIS datagate 340 through the HL7 server 306 or by the monitor acquisition module 310. The MedServer 312 also accesses a local area static database 332, an ICU database 330, and a management database for related devices 328. The local area static database 332 includes data that rarely changes and is hospital specific, such as local general information about hotels and restaurants, and descriptions of the types of monitoring equipment used. The ICU team database 330 includes physician and nurse biographies and qualifications. Finally, the management database for related devices 328 includes descriptions of the types of monitoring equipment used.

The local area static database 332, the ICU Team Database 330, and the management database for related devices 328 are accessed by the web-based data entry and system configuration 334. The web-based data entry and system configuration 334 includes data entry forms used by the administrator to configure and maintain the systems. The data types supported are textual data, images, monitored parameters, labs, and ECG analysis. Textual data is preprocessed/abstracted reports from the HIS such as OP, CT, XR, DC, DS, or NC. The images include MRI, CT, and PET. The monitored parameters include current snapshots of BP, ICP, ECG, HR, BT, SAO2, and MAP. The Labs include the most recent plus charted trends for change of critical or peri-critical values and explanation of their meaning. Finally, the EEG analysis includes neurocritical reports.

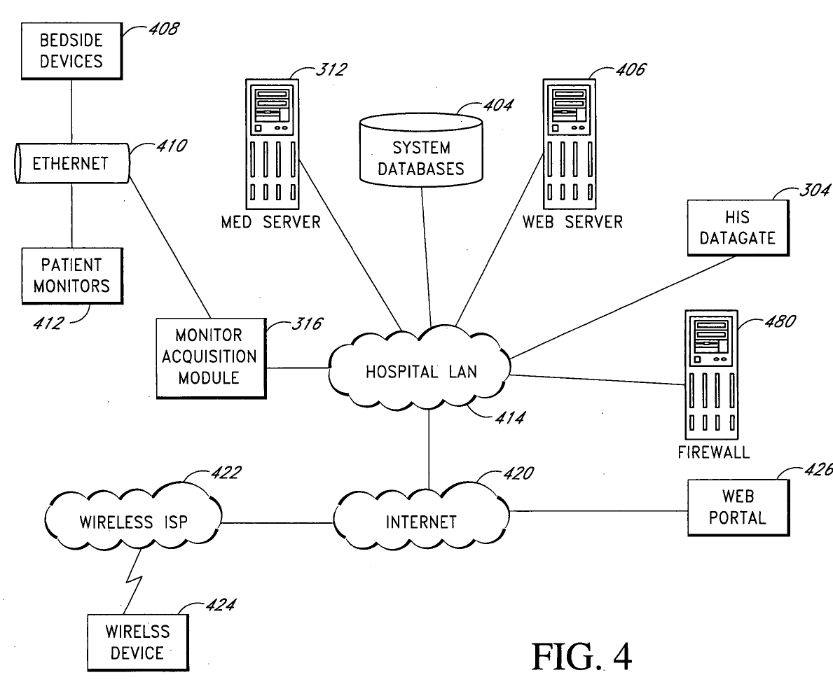

FIG. 4 shows a network diagram of the hospital-wide hardware and network infrastructure for the software shown in FIG. 3. Similar to the way software is differentiated, the hardware needed to support the system can also be differentiated so that there is hardware internal to the system provided at the time of installation and hardware external to the system and presumably existing in the hospital 102 already.

The internal hardware includes the MedServer 312, a web server 406, and the monitor acquisition module 310. Preferably, theses systems are Windows b 98/NT/2000/XP based computers with CPU speed greater than 500 MHz, memory greater than 64 MB of RAM, and a storage capacity greater than 1 GB. Depending on the traffic load at the particular hospital facility, these three separate pieces of hardware can be integrated into one machine or further distributed over many workstations using Network Load Balancing software (NLB) for Windows 2000.

The monitor acquisition nodule 310 is connected to the Ethernet line 410. The monitor acquisition module 310 acquires data from the bedside devices 408 and the patient monitors 412 through the Ethernet line 410. The three pieces of hardware are connected to the Hospital LAN 414. Data is stored in the system databases 404. The Hospital LAN is a fiber optic backbone based on Ethernet or TokenRing technology.

A firewall 480 ensures that data stored in the HIS datagate 304 is protected from users that access the web server 406 or the MedServer 312. The firewall methodology is any standard methodology as recognized by one of ordinary skill in the art, such as, for example, a proxy server.

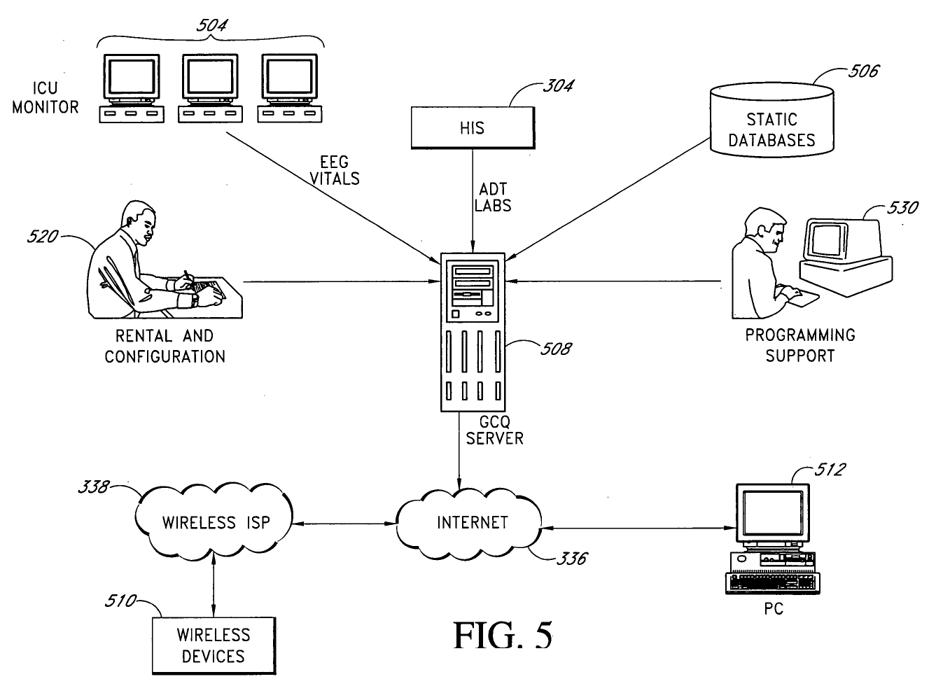

FIG. 5 is a schematic view of the support system used to maintain the software and hardware configurations shown in FIGS. 3 and 4. The GCQ server 508 receives EEG and vitals from the ICU monitors 504, ADT and Lab data from the HIS 304, and data from the static databases 506. The rental and configuration personnel 520 includes an administrator that monitors the service on a daily basis and staff that dispense handheld devices or software modules to end-users. The programming support personnel 530 set up and maintain the service. The GCQ server 508 is connected to the Internet 336. A PC 512, a wireless device 510 with access to the wireless ISP 338, or both are connected to the Internet 336.

Electronic patient records are guarded with stringent security features, which include biometric user authentication via electronic signatures and device serial numbers, user authorization using encrypted passwords, and encryption of all textual data. In addition, all patient relevant data is permanently stored on the GCQ server 508 side and only segments of it are maintained temporarily on the handheld device for the purpose of off-line patient management. The data are promptly uploaded to the GCQ server 508 by wireless or through hot sync technology.

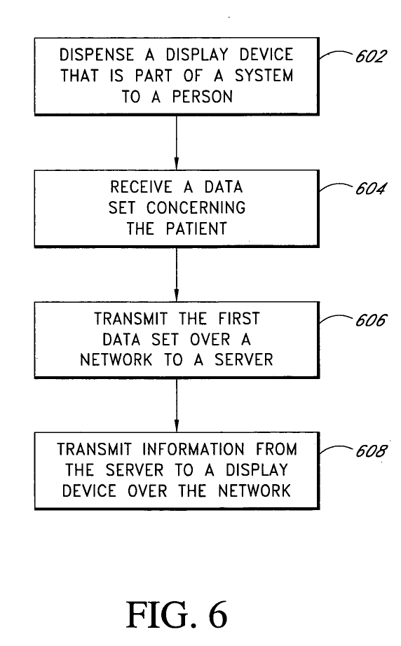

FIG. 6 shows one embodiment of a method for providing information to a display device 110 in the possession of the person affiliated with the patient. As discussed above with respect to FIG. 1, the dispenser 108 of the display device 110 can be the hospital 102 or a third party vendor. In a step 602, a display device that is part of a system is dispensed to the person affiliated with the patient. As discussed above, the display device is preferably integrated with a computing device such as, for example, a PDA. After learning that the patient is in the hospital, the person affiliated with the patient can purchase, rent, or borrow the display device from the dispenser. In one embodiment discussed above, the person can simply go to a dispensing machine to retrieve a PDA or to retrieve a software module for the person's own PDA.

In a step 604, a data set concerning the patient is received from the sensor 106 by the server 206 as shown in FIG. 2. Alternatively, the data set can also be received from medical personnel making observations and transmitting the data to the server. In one embodiment, a handheld device used to receive data from the server can also be used by medical personnel to transmit patient related information to the server.

In a step 606, the data set is transmitted to the server 206. The data set is digitized before transmission to the server. If the data set needs to be processed for so that the person can understand it, the server 206 can transmit the data set to the data processing module 210 as shown in FIG. 2.

In a step 608, at least a part of the stored patient information in the data file 208 can be transmitted to a display device 110 over the network 212. The display device is preferably integrated with a computing device as discussed above.

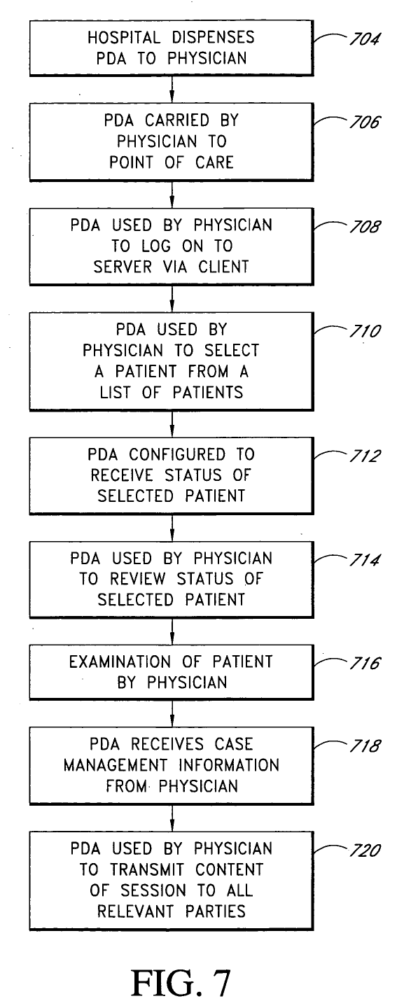

FIG. 7 shows one embodiment of a method for dispensing device 110 to medical personnel to communicate with a hospital regarding patient related information. Although relatives of patients are the individuals that presently have the least amount of information, renting devices to medical personnel can improve the medical care process by providing care givers with more organized and centrally located data. As described above with respect to FIG. 1, in one embodiment, the device can be a wireless device or a web based client.

In a step 704, the hospital 102 dispenses a PDA to a physician (or another caregiver, such as a nurse). By providing the physician with a wireless handheld device such as a PDA, the physician can execute and complete all necessary functions, such as, for example, clinical, management, administrative, and billing tasks. These functions are normally performed in multiple sessions with and without the patient. For example, a doctor presently records clinical data in the presence of the patient and records most administrative data outside the presence of the patient. The physician advantageously uses the PDA to perform these functions in a single session with the patient. One embodiment includes a schedule notification feature that automatically notifies a physician when a patient has arrived in the hospital. The schedule notification feature also notifies the physician that the patient is fully induced/anaesthetized in the Operating Room (OR). The physician can thereby adjust his or her schedule accordingly to time the patient's arrival.

In a step 706, the physician carries the PDA to a point of care. The point of care can be a hospital ward bed, an ICU bed, or any other place where the physician encounters the patient. In a step 708, the physician logs on to the server 206 via client software loaded on to the PDA. The client software allows the physician to access the server 206, which in turn can access databases holding patient specific information. In a step 710, the physician selects the name of the patient from a list of patient names displayed on the PDA. After making the selection, the physician receives the status of the patient in a step 712 and reviews the status in a step 714.

In conjunction with the physician's review of at least a portion of the data stored in the data file 208, the physician conducts a physical examination of the patient in a step 716. In a step 718, the physician enters case management information, which includes the physician's observations and administrative, clinical, and historical data. For example, the physician enters diagnoses, recommendations, and billing data into the data file 208 via the handheld device 110. The physician records observations and notes on the PDA to be stored in the data file 208. The PDA also transmits the data to the server 206, which stores the data in the data file 208 either as transmitted or after any necessary processing.

In a step 720, the physician can transmit data via the PDA. Data can be transmitted to the PDA in the possession of a person affiliated with the patient without the person making a request for the information. For example, the physician can page the person affiliated with the patient in the event of an emergency. Further, the physician can send an update to the person's PDA of the current status of the patient. In one embodiment, there is a multiple destination export feature which allows the history and physical exam notes written by the physician to be sent to multiple destinations such as, for example, a referring MD, a primary care MD, an HMO case-manager, other in-hospital care team members or consultants, MD office record, or a billing agent.

In one embodiment, the nurse transmits data over a PDA to a physician with a PDA. In an ICU environment, the process of taking care of the in-house hospitalized patients is cyclical in nature. The work flow in the ICU is such that nurses are constantly in the ICU and in contact with the ICU patients, while the physicians visit the ICU and interact with nurses and other caregivers periodically through day and night. At these times, the nurses are expected to report any new and significant changes in the patient's clinical status or other relevant observations or issues. There are two types of communication between nurses and doctors in terms of urgency. The first type of communication is routine, which waits for the physician to show up in the ICU. Some of these routine communications involve observations that cannot be automatically recorded and must be observed by medical personnel (e.g., vomiting, complaining, agitation). The second type is acute or urgent, which requires immediate contact and information exchange.

Routine communications can be recorded by the nurse on a PDA when the nurse makes an observation. The routine communications are stored in the patient specific dynamic databases 308. When the physician logs on through the physician's PDA, the physician can view the routine communications. This embodiment advantageously allows the nurse to make one recording of the observation at the time of its occurrence instead of waiting for a physician to enter the hospital 102 and be available for discussion. On the other hand, acute communications require immediate dispatch. The nurse can pipe a message with the use of the PDA to the physician's PDA to page the physician. In one embodiment, a time window is created to measure that amount of time that can pass before the physician does not receive the page and a repeated attempt to page must be made.

In another embodiment, after step 720, the physician's diagnosis is automatically coded by the system. The code is linked to an appropriate list of clinical guidelines. There are many web sites that publish clinical guidelines. The physician can then access an Internet site through a web hyperlink to view an evidence-based clinical practice guideline.

In one embodiment, a software module automatically formats a physician's notes for transmission to insurance companies. The software module includes an automated method for calculating CPT codes and exam level from check-marked entries mad by the physician or automatically entered at a from various data sources. In addition, the software module can also provide pricing information for services that the physician is about to perform or has performed.

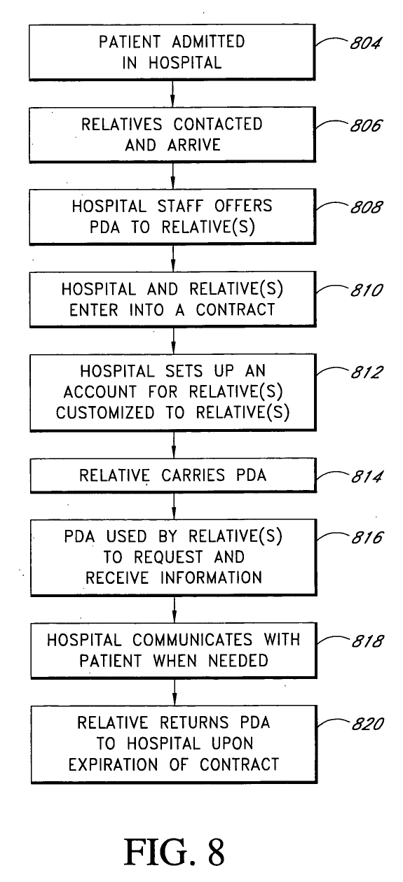

FIG. 8 shows one embodiment of a method for dispensing a PDA to a person affiliated with a patient (e.g., a relative or significant other). In a step 804, a patient is admitted into the hospital 102. In an optional step 806, relatives of the patient are contacted and arrive at the hospital 102 if they do not arrive with the patient. Alternatively, significant others or friends can also be contacted and arrive at the hospital 102.

In a step 808, the hospital offers to sell, rent, or lend a PDA or other handheld device to the relatives. Alternatively, a third party can dispense PDAs to the relatives. This offer can take place in the form of medical personnel asking the relatives to use the PDA. Alternatively, the offer can be an advertisement such as, for example, a sign or a television commercial. In a step 810, if the relatives accept the offer, the hospital and the relatives enter into a contract outlining usage and rental conditions for the PDA. Although some hospitals may choose to provide the PDA as a free service, the hospital generally will want to control the usage of the device to ensure that the device is returned and is not abused.

In a step 812, the hospital sets up a customized account for the relatives. In one embodiment, a PDA with limited access to the specific patient's data is dispensed to the relatives. In another embodiment, a PDA with access to the server 206 is given to the relatives along with log-on information specific to the specific patient.

In a step 814, the relative carries the PDA either inside the hospital or at a remote location. In a step 816, the relative uses the PDA to request patient related information or provide patient related information. Accordingly, the relative is advantageously enabled to take a more active role in the treatment of the patient than seen in present method of health care. In a step 818, the hospital communicates with the relatives as needed. As discussed above with respect to FIG. 7, the medical personnel are also enabled to communicate with the relatives by sending updates to the PDA or by paging the relatives in case of an emergency.

In a step 820, the relative returns the PDA to the hospital upon expiration of the contract. In another embodiment, the relative uses the relative's own PDA and borrows or rents a software module on a storage disk or storage card from the hospital. After the duration of the contract expires, the storage disk or storage card becomes non-operational. The relative can then discard the storage disk or storage card.

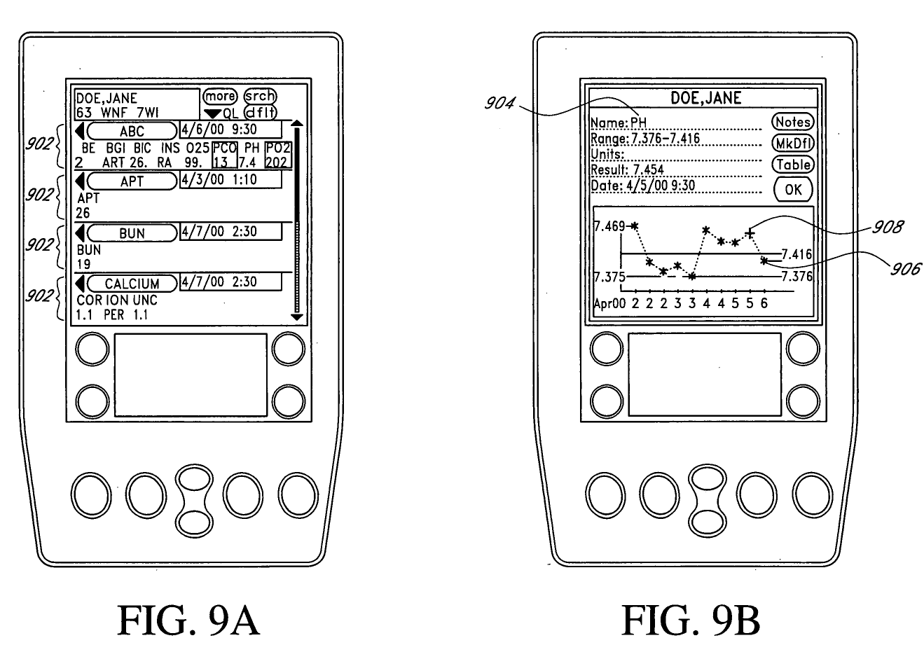

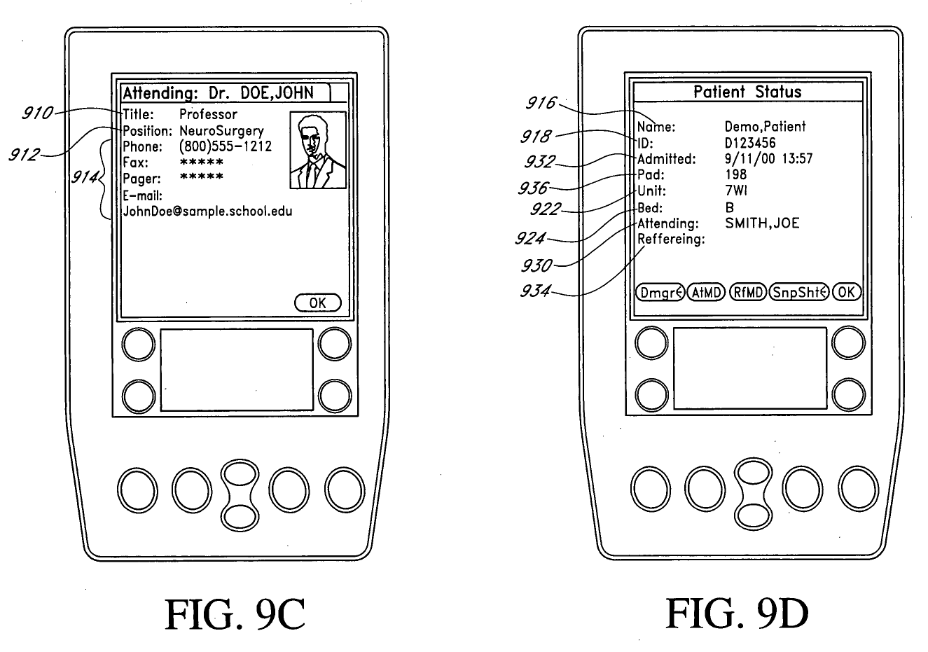

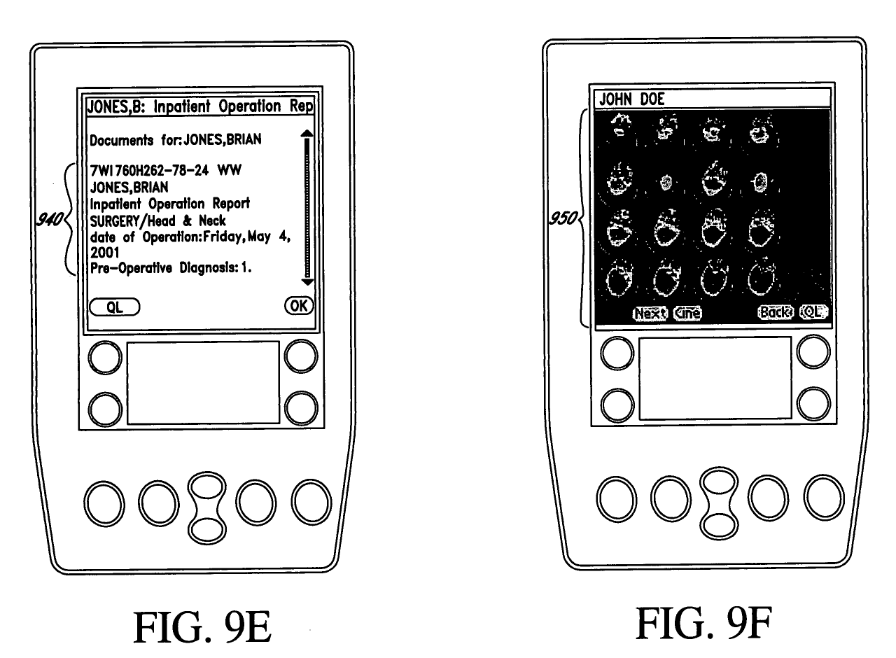

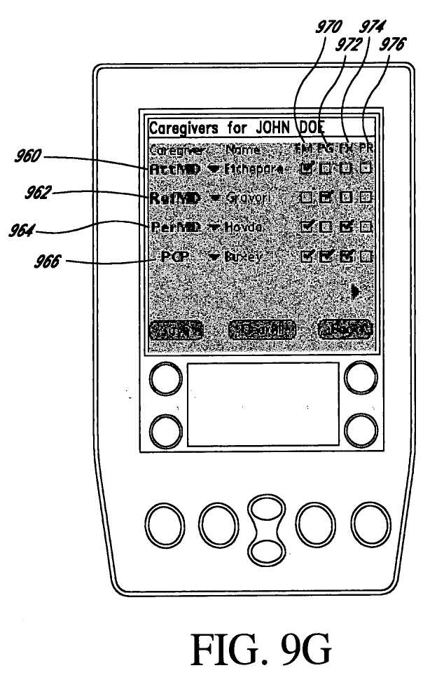

FIGS. 9A-9F are screen shots of the GUI seen by the person affiliated with the patient or the physician when using the display device 110. The exemplary screen shots are advantageously designed for the Palm platform to provide the maximum amount of relevant information in the limited 2D space of the Palm screen in an intuitive and user-friendly fashion with touch screen control over the mode of data displays. Similar screens are designed for the Windows CE/Power PC platform.

FIG. 9A shows a snapshot of clinical labs data. In contrast to the typical text-based form of display of lab data which is provided by the HIS, the lab data is organized into groups 902. The abnormal values are highlighted using a color coding scheme (e.g., white for normal range, blue for low and red for high values). The person affiliated with the patient can browse through the whole set of historical lab tests using the <and > arrows.

FIG. 9B shows the historical trend of one individual lab parameter pH 904. Touching the (*) symbols 906 on the graph with a stylus or a fingertip allows the user to read out individual parameter values for different test times. Touching the (+) symbol 908 shows associated lab notes.

FIG. 9C is a screen shot displaying biographical information regarding the attending physician. As discussed above, a person affiliated with the patient may become more comfortable about the treatment of the patient if the person knows more about the attending physician. A title field for the physician 910, a position field for the physician 912, and contact information fields 914 are displayed in the screen shot. The information is received from the HIS 304. Each communication mode in the communication fields can be activated by tapping on that communication mode.

FIG. 9D is a screen shot displaying the current patient status. A name field 916 displays the name of the patient while an id field 918 displays the id of the patient. If the person affiliated with the patient forgets the location of the patient, the person can view the unit field 922 and bed field 924 to determine the location of the patient. A variety of other information such as the attending physician field 930 can be found in the GUI. The current patient status is recorded in the HIS 304. Other data such as admission date 932, referring physicians 934, and a post admission day (pad) 936 can be accessed.

FIG. 9E is a screen shot displaying a clinical document. The clinical data 940 includes reports on treatment for the patient. The clinical data 940 also includes the physician's diagnosis.

FIG. 9F is a screen shot of a CT image thumb set 950 comprising a plurality of thumbnail-sized views of CT images. The person selects one of the plurality of CT images to view. After selecting a CT image to view, the person can select a window in a color table to show the best image possible for the range of Hounsfeld numbers associated with the CT image.

FIG. 9G shows a caregivers form. The person can assign names from an address book to individual caregiver roles. For example, names can be assigned to the caregiver role of Attending Physician in an AttMD field 960, to the caregiver role of Referring Physician in a RefMD field 962, to the caregiver role of Personal Physician in a PerMD field 964, and to the caregiver role of Primary Care Physician in a PCP field 966. For each of the caregivers, the person selects a preferred mode of communication. The person selects a mode of communication by checking a box in an EM field 970 for e-mail, checking a box in a PG field 972 for pager, checking a box in a FX field 974 for fax, or checking a box in a PR field 976 for printer. These preferences are saved for future use. Forms and other documents can be transmitted to the caregivers according to the saved preferred modes of communication.

In yet another embodiment of the GUI, a variety of data types can be displayed on the space-limited screen of handheld devices. The variety of data types includes sporadic time series (e.g., lab tests, Glasgow Coma Score (GCS)) and continuous time series (e.g., vital signs and their trends, continuous EEG and trends). The results of Lab tests are displayed in tabular, graphic trend and chronological paging mode. Switching between these display modalities is achieved with a single tap of the stylus. Continuous trends captured from the bedside monitors are also displayed in a graphical format. With one-tap of the stylus, there is a readout of the values of all vital sign parameters associated with a given time stamp.

While the above description contains many specifics, these should not be construed as limitations on the scope of the invention, but rather as an exemplification of preferred embodiments thereof. One skilled in the art will recognize that many of the various features and capabilities described in connection with the invention are also applicable to other embodiments as well. One skilled in the art will recognize that these features, and thus the scope of the present invention, should be interpreted in light of the following claims and any equivalents thereto.

What is claimed is:

1. A method of supplying information concerning a patient, the method comprising:
providing a display device that is a dedicated part of a system to a person, the display device configured to display information concerning a patient, wherein the system:
receives a first data set concerning the patient;
transmits the first data set in digitized form to a server and stores the first data set as patient information; and
transmits at least a portion of the stored patient information from the server to the display device.

2. The method of claim 1, further comprising processing the first data set before the portion of the data set is transmitted from the server to the display device.

3. The method of claim 2, further comprising processing the data set for access by a speech recognition system.

4. The method of claim 1, wherein the information transmitted from the server includes at least a portion of the data from the first data set.

5. The method of claim 1, wherein the data set concerning the patient includes vital sign data.

6. The method of claim 1, wherein the data set concerning the patient includes historical data concerning the patient.

7. The method of claim 1, wherein the data set concerning the patient includes physical examination data.

8. The method of claim 1, wherein the data set concerning the patient includes lab result data.

9. The method of claim 1, wherein the data set concerning the patient includes imaging results data.

10. The method of claim 1, wherein the person is a relative of the patient.

11. The method of claim 1, wherein the person is a friend of the patient.

12. The method of claim 1, wherein the person is a physician.

13. The method of claim 1, wherein the person is a nurse.

14. The method of claim 1, wherein the person is a member of medical personnel.

15. The method of claim 1, wherein the display device is integrated with a computing device to allow display of the information.

16. The method of claim 15, wherein the computing device is a Personal Digital Assistant.

17. The method of claim 15, wherein the computing device is a two-way pager with Personal Digital Assistant functionality.

18. The method of claim 15, wherein the computing device is a Wireless Application Protocol phone.

19. The method of claim 15, wherein the computing device is a microprocessor-based computer.

20. The method of claim 15, wherein the computing device is wireless.

21. The method of claim 1, wherein the information is transmitted from the server from a radio frequency transmitter to a radio frequency receiver.

22. The method of claim 1, wherein the information includes case management information.

23. The method of claim 22, wherein the case management information includes administrative data.

24. The method of claim 22, wherein the case management information includes clinical data.

25. The method of claim 1, wherein providing is renting.

26. The method of claim 1, wherein providing is selling.

27. The method of claim 1, wherein providing is lending.

28. A method of supplying information concerning a patient, the method comprising:
providing a display device to a person, the display device configured to display information concerning a patient;
receiving a first data set concerning the patient;
transmitting the first data set in digitized form to a server;
storing the first data set as patient information; and
transmitting at least a portion of the stored patient information from the server to the display device.

29. The method of claim 28, wherein the person is a relative of the patient.

30. The method of claim 28, wherein the person is a friend of the patient.

31. The method of claim 28, wherein the person is a physician.

32. The method of claim 28, wherein the person is a nurse.

33. The method of claim 28, wherein the person is a member of medical personnel.

34. The method of claim 28, wherein providing is renting.

35. The method of claim 28, wherein providing is selling.

36. The method of claim 28, wherein providing is lending.

37. The method of claim 28, wherein the data set concerning the patient includes vital sign data.

38. The method of claim 28, wherein the data set concerning the patient includes historical data concerning the patient.

39. The method of claim 28, wherein the data set concerning the patient includes physical examination data.

40. The method of claim 28, wherein the data set concerning the patient includes lab result data.

41. The method of claim 28, wherein the data set concerning the patient includes imaging results data.

42. The method of claim 28, wherein the display device is integrated with a computing device to allow display of the information.

43. The method of claim 28, wherein the computing device is a Personal Digital Assistant.

44. The method of claim 28, wherein the computing device is a two-way pager with Personal Digital Assistant functionality.

45. The method of claim 28, wherein the computing device is a Wireless Application Protocol phone.

46. The method of claim 28, wherein the computing device is a microprocessor-based computer.

47. The method of claim 28, wherein the computing device is wireless.

48. A method of providing information concerning a patient, the method comprising:
dispensing a display device that is a dedicated part of a system to a person, the display device configured to display information concerning a patient, wherein the system:
receives a first data set concerning the patient;
transmits the first data set in digitized form over a network to a server that stores the first data set as patient information;
transmits at least a portion of the patient information from the server to a display device over the network; and
receives additional patient information over the network from a person to enhance delivery of health care to the patient.

49. The method of claim 48, wherein dispensing is renting.

50. The method of claim 48, wherein dispensing is selling.

51. The method of claim 48, wherein dispensing is lending.

52. The method of claim 48, wherein the user is a relative of the patient.

53. The method of claim 48, wherein the additional patient information received over the network includes data that is different from data in the first data set.

54. The method of claim 48, wherein the person is a friend of the patient.

55. The method of claim 48, wherein the person is a physician.

56. The method of claim 48, wherein the person is a nurse.

57. The method of claim 48, wherein the person is a member of medical personnel.

58. The method of claim 48, wherein the display device is integrated with a computing device to allow display of the information.

59. A system of providing information concerning a patient, the system comprising:
a hospital information service, which manages patient related information;
a first server, which receives data from the hospital information service;
a first database in which the first server stores data;
patient monitors which receive a data set concerning a patient;
a monitor acquisition module which receives data from the patient monitors;
a second database in which the monitor acquisition module stores the data from the patient monitors; and
a second server which accesses the second database and transmits data over a network to a display device that is dispensed to a person.

60. The system of claim 59, wherein the first database and the second database are in a combined database.

61. The system of claim 59, wherein the display device is integrated with a computing device to allow display of the information.

62. The system of claim 59, further comprising a firewall that protects patient related information managed accessed by the first server from access by the second server.

63. A method of renting a device to a person affiliated with a patient situated in a hospital, the method comprising:
contacting the person to make the person an offer to rent the device;
entering into a contract with the person regarding usage and rental conditions;
creating a customized account for the person; and
providing communication capability between the hospital and the person wherein the person can request and receive patient related information via the device, and the hospital can communicate with the patient when needed.

64. The method of claim 63, wherein the device is wireless.

65. The method of claim 63, wherein the device is a PDA.

66. The method of claim 63, wherein the customized account includes a level of access, an enabled service, or a charge level.

67. The method of claim 63, wherein the patient related information includes at least one of patient specific information, hospital specific information, or disease specific information.

68. The method of claim 63, wherein the hospital can page the person via the device.

69. A method of providing a communication service between a hospital and a person affiliated with a patient, the method comprising:
contacting the person to make the person an offer to buy the communication service;
entering into a contract with the person regarding usage and purchase conditions;
loading a software module on to the PDA of the person;
activating the software module for the duration of the contract; and
providing communication capability between the hospital and the person, wherein the person can request and receive patient-related information.

70. The method of claim 69, wherein the person is a friend of the patient.

71. The method of claim 69, wherein the person is a physician.

72. The method of claim 69, wherein the person is a nurse.

73. The method of claim 69, wherein the person is a member of medical personnel.

74. A method of providing a display device to medical personnel to communicate with a hospital regarding patient-related information, the method comprising:
dispensing a display device to a medical person;
enabling the medical person to log on to a server via the display device;
providing to the medical person a list of patients via the display device;
transmitting to the medical person relevant patient specific data in response to a selection made by the medical person from the list of patients;
receiving case management information entered by the medical person via the display device after reviewing the patient specific data and examining the patient, and
providing the physician with transmission capabilities through the display device for the data in the session.

75. The method of claim 74, wherein the medical person is a doctor.

76. The method of claim 74, wherein the medical personnel is a nurse.

77. The method of claim 74, wherein the case management information includes clinical data.

78. The method of claim 74, wherein the case management information includes administrative data.

79. The method of claim 74, wherein the device is a wireless device.

80. The method of claim 74, wherein the device is a web-based client.

81. A method of providing information concerning a patient, the method comprising:
dispensing a software module configured to be integrated with a display device that is a dedicated part of a system to a person, the display device configured to display information concerning a patient, wherein the system
receives a first data set concerning the patient;
transmits the first data set in digitized form over a network to a server for storage therein as patient information; and
transmits at least a portion of the patient information from the server to a display device over the network.
